(19) United States
(12) Patent Application Publication
(10) Pub. No.: US 2022/0298349 A1
(43) Pub. Date: Sep. 22, 2022

(54) Aqueous resin emulsion

(71) Applicant: Henkel AG & Co., KGaA, Dusseldorf (DE)

(72) Inventor: Yoshio Yoshida, Osaka (JP)

(21) Appl. No.: 17/806,000

(22) Filed: Jun. 8, 2022

Related U.S. Application Data
(63) Continuation of application No. PCT/JP2020/045951, filed on Dec. 10, 2020.

(30) Foreign Application Priority Data
Dec. 12, 2019 (JP) 2019-224681

(51) Int. Cl. C08L 33/08; C08L 33/12; C08F 2/00; C08F 2/26; C08F 220/14; C08F 220/18; C08F 220/06; C08F 230/08

(52) U.S. Cl. CPC C08L 33/08; C08L 33/12; C08F 2/001; C08F 2/26; C08F 220/14; C08F 220/1804; C08F 220/06; C08F 220/1806; C08F 220/1808; C08F 230/085; C08L 2201/52

(57) ABSTRACT

Disclosed is an aqueous resin emulsion obtainable by multistage emulsion polymerization of plural kinds of polymerizable unsaturated monomers in the presence of a surfactant, (a) a polymerizable unsaturated monomer being polymerized in a stage other than the final stage, while (b) a polymerizable unsaturated monomer being polymerized in the final stage, wherein the surfactant comprises a sulfate ester salt having an allyl group and a polyoxyethylene group, and the aqueous resin emulsion comprises a copolymer of the specific polymerizable unsaturated monomer (a) and a copolymer of the specific polymerizable unsaturated monomer (b).

### TECHNICAL FIELD

The present invention relates to an aqueous resin emulsion obtainable by multistage emulsion polymerization, an aqueous resin composition comprising the aqueous resin emulsion, and substrates such as papers and plastics coated with the aqueous resin composition.

### BACKGROUND ART

An aqueous resin emulsion is produced by emulsion polymerization of a polymerizable unsaturated monomer in the presence of various surfactants. The aqueous resin emulsion thus obtained is used, for example, as a raw material for paints, adhesives, and coating agents for papers and plastics and so on.

The emulsion polymerization is excellent in terms of environment and safety since use of a large amount of an organic solvent like solution polymerization is not necessary and difficulty to perform slow cooling like bulk polymerization is not present. However, it is possible to exemplify, as a disadvantage of the emulsion polymerization, the fact that the mechanical stability of the emulsion can be insufficient because impurities easily enters into the aqueous resin emulsion and it is not easy to stably disperse the emulsion.

Patent Literature 1 discloses an aqueous pressure-sensitive adhesive wherein two kinds of emulsions having different glass transition temperatures are mixed (i.e., comprising two kinds of aqueous resins having different glass transition temperatures) (see [claim 1] and Table 1 to Table 4 in Examples). The aqueous pressure-sensitive adhesive of Patent Literature 1 exhibits satisfactory curved surface adhesion because of its high retention, and is capable of preventing the pressure-sensitive adhesive from adhering to a cutter when a pressure-sensitive adhesive product is fabricated by the cutter (see Table 3 in [0141]).

Patent Literature 2 discloses that an aqueous resin is prepared by multistage emulsion polymerization of a polymerizable monomer and a floor polish is produced from the aqueous resin (see [0019] and [0153] Table 5 to [0156] Table 8). The multistage emulsion polymerization of the polymerizable monomer enables an improvement in durability (specifically, water resistance and black heel mark resistance) of the aqueous resin emulsion. Therefore, the aqueous resin emulsion of Patent Literature 2 is suitable as a raw material for floor polish.

### CITATION LIST

### Patent Literature

[PTL 1] JP 2016-117785 A

[PTL 2] JP 2016-98358 A

### SUMMARY OF INVENTION

### Technical Problem

As mentioned above, the aqueous resin emulsion of Patent Literature 1 is suitable as a raw material for an aqueous pressure-sensitive adhesive, and the aqueous resin emulsion of Patent Literature 2 is best suited as an aqueous resin for floor polish. However, the aqueous resin emulsion is used in various fields, in addition to the above applications. For example, there are applications in which the aqueous resin emulsion is directly applied onto substrates such as papers and films, inorganic materials, and there are applications in which a resin layer formed on the substrate is covered with the emulsion composition to thereby protect the substrate.

Considering the uses of the aqueous resin emulsion in various applications, it is desirable for the aqueous resin emulsion to have excellent durability of other kinds (e.g., alcohol resistance, ester-based solvent resistance, plasticizer resistance, etc.) at a higher level, in addition to retention (or retentivity) and water resistance.

### Solution to Problem

The present invention has been made to solve the above-mentioned problems and an object thereof is to provide an aqueous resin composition having excellent water resistance, alcohol resistance, ester-based solvent resistance and plasticizer resistance, which can be applied onto various substrates and is capable of protecting the substrate by protecting a resin layer formed in advance on the substrate by coating, an aqueous resin emulsion which is a main component of the aqueous resin composition, and a substrate coated with the aqueous resin composition.

As a result of intensive study to solve the above-mentioned problems, the present inventors have found that when a specific polymerizable unsaturated monomer is subjected to multistage emulsion polymerization in the presence of a specific surfactant, an aqueous resin emulsion thus obtained is excellent in durability (water resistance, alcohol resistance, ester-based solvent resistance and plasticizer resistance) and an aqueous resin composition comprising this aqueous resin emulsion can be applied onto various substrates and the coated substrate thus obtainable is excellent in durability, thus completing the present invention.

The present invention and preferred embodiments of the present invention are as follows:

1. An aqueous resin emulsion obtainable by multistage emulsion polymerization of plural kinds of polymerizable unsaturated monomers in the presence of a surfactant, (a) a polymerizable unsaturated monomer being polymerized in a stage other than the final stage, while (b) a polymerizable unsaturated monomer being polymerized in the final stage, wherein the surfactant comprises a sulfate ester salt having an allyl group and a polyoxyethylene group, the aqueous resin emulsion comprises a copolymer of the polymerizable unsaturated monomer (a) and a copolymer of the polymerizable unsaturated monomer (b), the copolymer of the polymerizable unsaturated monomer (a) has a glass transition temperature lower than that of the copolymer of the polymerizable unsaturated monomer (b), the polymerizable unsaturated monomer (a) and the polymerizable unsaturated monomer (b) comprise a (meth)acrylic acid ester and a monomer having an alkoxysilyl group and an ethylenic double bond, and the polymerizable unsaturated monomer (a) comprises (a2) a monomer having an alkoxysilyl group and an ethylenic double bond in an amount of 0.05 to 1.0 parts by mass per 100 parts by mass of the polymerizable unsaturated monomer (a).

2. The aqueous resin emulsion according to 1, wherein the polymerizable unsaturated monomer (a) further comprises a monomer having a carboxyl group.

3. The aqueous resin emulsion according to 1 or 2, wherein the polymerizable unsaturated monomer (b) comprises (b2) a monomer having an alkoxysilyl group and an ethylenic double bond in an amount of 0.01 to 1.0 parts by mass per 100 parts by mass of the polymerizable unsaturated monomer (b).

4. The aqueous resin emulsion according to any one of 1 to 3, wherein the mass ratio ((b)/(a)) of (b) to (a) is 30/70 to 70/30.

5. An aqueous resin composition comprising the aqueous resin emulsion according to any one of 1 to 4.

6. A substrate coated with the aqueous resin composition according to 5.

### Advantageous Effects of Invention

An aqueous resin emulsion according to an embodiment of the present invention is obtainable by multistage emulsion polymerization of plural kinds of polymerizable unsaturated monomers in the presence of a surfactant, and when the surfactant comprises a sulfate ester salt having an allyl group and a polyoxyethylene group, and the polymerizable unsaturated monomer comprises an (meth)acrylic acid ester, it becomes possible to achieve significantly excellent durability (water resistance, alcohol resistance, solvent resistance and plasticizer resistance).

An aqueous resin composition comprising the aqueous resin emulsion according to the embodiment of the present invention can be applied onto various substrates, and it also becomes possible to protect a layer formed in advance on the substrate. The coated substrate has a high level of various durability performances and can be used for various applications

### DESCRIPTION OF EMBODIMENTS

An aqueous resin emulsion according to an embodiment of the present invention is obtainable by multistage emulsion polymerization of a polymerizable unsaturated monomer in the presence of a specific surfactant.

### <Surfactant>

The surfactant is used to form an emulsion of an aqueous medium with a monomer mixture, and has a hydrophilic group which is easily compatible with water and a lipophilic (hydrophobic) group which is easily compatible with oil in the molecule. When a small amount of the surfactant is dissolved in a solvent, the surface tension of the solution is significantly reduced by the surfactant and polymer solids (dispersoid) can be uniformly dispersed in the aqueous medium.

The “surfactant” in the present disclosure includes a sulfate ester salt having an allyl group (2-propenyl group: CH2=CH—CH2-) and a polyoxyethylene group ((OCH2CH2)n). The presence of the sulfate ester salt having an allyl group and a polyoxyethylene group makes the aqueous resin emulsion according to the embodiment of the present invention excellent in water resistance.

Examples of the sulfate ester salt having an allyl group and a polyoxyethylene group include a sulfate ester ammonium salt having an allyl group and a polyoxyethylene group, a sulfate ester sodium salt having an allyl group and a polyoxyethylene group, and a sulfate ester potassium salt having an allyl group and a polyoxyethylene group.

Specifically, it is possible to exemplify:

a polyoxyethylene-1-(allyloxymethyl)alkyl ether sulfate ester ammonium salt, a polyoxyethylene-1-(allyloxymethyl)alkyl ether sulfate ester sodium salt, a polyoxyethylene-1-(allyloxymethyl)alkyl ether sulfate ester potassium salt; an α-[1-[(allyloxy)methyl]-2-(nonylphenoxy)ethyl]-ω-polyoxyethylenesulfate ester ammonium salt, an α-[1-[(allyloxy)methyl]-2-(nonylphenoxy)ethyl]-ω-polyoxyethylenesulfate ester sodium salt, an α-[1-[(allyloxy)methyl]-2-(nonylphenoxy)ethyl]-ω-polyoxyethylenesulfate ester potassium salt; and the like. These sulfate ester salts may be used alone or in combination.

The sulfate ester salt having an allyl group and a polyoxyethylene group according to the embodiment of the present invention is preferably a sulfate ester ammonium salt. Namely, a polyoxyethylene-1-(allyloxymethyl)alkyl ether sulfate ester ammonium salt and an α-[1-[(allyloxy)methyl]-2-(nonylphenoxy)ethyl]-ω-polyoxyethylenesulfate ester ammonium salt are preferable, and especially a polyoxyethylene-1-(allyloxymethyl)alkyl ether sulfate ester ammonium salt is most preferable.

When the surfactant comprises the sulfate ester ammonium salt having an allyl group and a polyoxyethylene group, the water resistance of the aqueous resin emulsion is more improved.

Examples of commercially available products of the sulfate ester salt having an allyl group and a polyoxyethylene group include (“AQUALON KH-10” (trade name): polyoxyethylene chain length of 10) and (“AQUALON KH-1025” (trade name): 25% aqueous solution of AQUALON KH-10) manufactured by Dai-ichi Kogyo Seiyaku Co., Ltd. as the polyoxyethylene-1-(allyloxymethyl)alkyl ether sulfate ester ammonium salt; and

“Adecaria Soap SR-1025 (trade name)” manufactured by Asahi Denka Co., Ltd. as the α-[1-[(allyloxy)methyl]-2-(nonylphenoxy)ethyl]-ω-polyoxyethylenesulfate ester salt.

### <Polymerizable Unsaturated Monomer>

In the embodiment of the present invention, the “polymerizable unsaturated monomer” means a radical polymerizable monomer having an ethylenic double bond.

In the present description the “ethylenic double bond” means a double bond between carbon atoms which can undergo a polymerization reaction (radical polymerization). Examples of the functional group having an ethylenic double bond include vinyl group (CH2=CH—), (meth)allyl group (CH2=CH—CH2- and CH2=C(CH3)-CH2-), (meth)acryloyloxy group (CH2=CH—COO— and CH2=C(CH3)-COO—), (meth)acryloyloxyalkyl groups (CH2=CH—COO—R— and CH2=C(CH3)-COO—R—) and —COO—CH═CH—COO— and the like.

In the embodiment of the present invention, the “polymerizable unsaturated monomer” includes an (meth)acrylic acid ester.

In the present description, the “(meth)acrylic acid” means both acrylic acid and methacrylic acid, and includes at least one of acrylic acid and methacrylic acid.

The “(meth)acrylic acid ester” means an ester of (meth)acrylic acid, i.e. (meth)acrylate. The (meth)acrylate means both acrylate and methacrylate, and include at least one of acrylate and methacrylate. Note that a vinyl ester having a structure in which a vinyl group and oxygen are bonded each other, for example, vinyl acetate is not included in the (meth)acrylate in the present specification.

Specific examples of the (meth)acrylate include (meth)acrylic acid alkyl esters such as methyl (meth)acrylate, ethyl (meth)acrylate, propyl (meth)acrylate, isopropyl (meth)acrylate, butyl (meth)acrylate, 2-ethylhexyl (meth)acrylate, pentyl (meth)acrylate, hexyl (meth)acrylate, cyclohexyl (meth)acrylate, octyl (meth)acrylate, decyl (meth)acrylate, dodecyl (meth)acrylate, tridecyl (meth)acrylate, octadecyl (meth)acrylate, behenyl (meth)acrylate, docosyl (meth)acrylate and the like; and (meth)acrylic acid hydroxyalkyl esters such as 2-hydroxyethyl (meth)acrylate, 2-hydroxybutyl (meth)acrylate, 2-hydroxypropyl (meth)acrylate and the like.

These (meth)acrylates can be used alone, or in combination of two or more kinds thereof.

In the embodiment of the present invention, the (meth)acrylic acid ester is preferably a (meth)acrylic acid alkyl ester. More specifically, it is preferable to comprise methyl (meth)acrylate, butyl (meth)acrylate, 2-ethylhexyl (meth)acrylate or cyclohexyl (meth)acrylate, and it is particularly preferable to comprise at least one selected from n-butyl acrylate and 2-ethylhexyl acrylate. The (meth)acrylic acid alkyl ester comprises a (meth)acrylic acid cycloalkyl ester.

When these monomers are mixed to form a monomer emulsion and a pre-emulsion is prepared, and then an aqueous resin emulsion is finally prepared by multistage emulsion polymerization, it becomes easy to control the glass transition temperature of the pre-emulsion and the aqueous resin emulsion (final product), thus enabling an improvement in water resistance and so on of the aqueous resin emulsion.

In the embodiment of the present invention, the polymerizable unsaturated monomer can include, in addition to the (meth)acrylic acid ester, a “monomer having an alkoxysilyl group and an ethylenic double bond” and/or a “monomer having a carboxyl group”.

The monomer having an alkoxysilyl group and an ethylenic double bond means a compound capable of imparting an alkoxysilyl group to the aqueous resin emulsion obtainable by the emulsion polymerization reaction, and is not particularly limited as long as the aqueous resin emulsion according to the embodiment of the present invention can be obtainable.

The monomer having an alkoxysilyl group and an ethylenic double bond has both an alkoxysilyl group and an ethylenic double bond, and the alkoxysilyl group and the ethylenic double bond may be bonded via other functional groups such as an ester bond, an amide bond, an alkylene group and the like.

Here, the “alkoxysilyl group” means a silicon-containing functional group capable of giving a hydroxyl group (Si—OH) which is bonded to silicon by hydrolysis. Examples of the “alkoxysilyl group” include alkoxysilyl groups such as trimethoxysilyl group, triethoxysilyl group, dimethoxysilyl group, dimethoxymethylsilyl group, diethoxysilyl group, monoethoxysilyl group and monomethoxysilyl group. The trimethoxysilyl group and the triethoxysilyl group are particularly preferable. The “ethylenic double bond” is as mentioned above.

The monomer having an alkoxysilyl group and an ethylenic double bond is not included in the above-mentioned (meth)acrylic acid ester.

In the embodiment of the present invention, when the polymerizable unsaturated monomer comprises the “monomer having an alkoxysilyl group and an ethylene double bond”, the aqueous resin, which becomes a dispersoid, has an alkoxysilyl group. When a coating film formed from the aqueous resin composition comprising the aqueous resin emulsion according to the embodiment of the present invention is dried, the alkoxysilyl group undergoes a dehydration condensation reaction and crosslinking in the coating film to form a crosslinked structure inside the aqueous resin or between the aqueous resins, thus making it possible to contribute to an improvement in durability (water resistance, alcohol resistance, solvent resistance, plasticizer resistance) and so on of the coating film.

It is possible to exemplify, as the monomer having an alkoxysilyl group and an ethylenic double bond, a compound represented by the following formula (1):

R1 Si(OR2)(OR3)(OR4) (1)

wherein, in the formula (1), R1 is a functional group having an ethylenic double bond, R2, R3 and R4 are an alkyl group having 1 to 5 carbon atoms, and R2, R3 and R4 may be the same or different from each other.

Examples of the functional group having an ethylenic double bond for R1 include vinyl group, (meth)allyl group, (meth)acryloyloxy group, 2-(meth)acryloyloxyethyl group, 2-(meth)acryloyloxypropyl group, 3-(meth)acryloyloxypropyl group, 2-(meth)acryloyloxybutyl group, 3-(meth)acryloyloxybutyl group and 4-(meth)acryloyloxybutyl.

Examples of the alkyl group having 1 to 5 carbon atoms for R2, R3 and R4 include linear or branched alkyl groups such as methyl group, ethyl group, n-propyl group, isopropyl group, n-butyl group, isobutyl group, sec-butyl group, t-butyl group, n-pentyl group and the like. Examples of the “monomer having an alkoxysilyl group and an ethylenic double bond” include vinyltrialkoxysilanes such as vinyltrimethoxysilane, vinyltriethoxysilane and vinyltri-n-butoxysilane.

Specifically, 3-(meth)acryloyloxypropyltrimethoxysilane and 3-(meth)acryloyloxypropyltriethoxysilane are preferable, and 3-(meth)acryloyloxypropyltrimethoxysilane is particularly preferable. Use of 3-(meth)acryloyloxypropyltrimethoxysilane enables further improvement in durability of the aqueous resin emulsion according to the embodiment of the present invention.

These monomers having an alkoxysilyl group and an ethylenic double bond can be used alone or in combination.

In the embodiment of the present invention, the polymerizable unsaturated monomer can further include a “monomer having a carboxyl group”. Examples of the monomer having a carboxyl group include (meth)acrylic acid. As mentioned above, the (meth)acrylic acid means both acrylic acid and methacrylic acid. It is preferable to use acrylic acid as the (meth)acrylic acid. It is also possible to exemplify unsaturated carboxylic acids such as itaconic acid, fumaric acid, maleic acid and the like, and monoesters thereof.

In the embodiment of the present invention, as long as the objective aqueous resin emulsion can be obtainable, the polymerizable unsaturated monomer may include “other monomers”. Other monomers mean monomers other than the (meth)acrylic acid ester, the monomer having an alkoxysilyl group and an ethylenic double bond, and the monomer having a carboxyl group.

Examples of “other monomers” include, but are not limited to: styrene-based monomers such as styrene and styrenesulfonic acid; and acrylamides such as (meth)acrylamide and diacetone (meth)acrylamide.

### <Multistage Emulsion Polymerization>

The aqueous resin emulsion according to the embodiment of the present invention is obtainable by multistage emulsification polymerization of a polymerizable unsaturated monomer in the presence of a surfactant, wherein (a) a polymerizable unsaturated monomer is polymerized in a stage other than the final stage, while (b) a polymerizable unsaturated monomer is polymerized in the final stage.

In the present description, it is possible to obtain the aqueous resin emulsion by emulsification polymerization of the polymerizable unsaturated monomer in a plurality of stages (substantially two stages). The polymerizable unsaturated monomer used during polymerization in the stage other than the final stage is defined as (a), while the polymerizable unsaturated monomer used during polymerization in the final stage is defined as (b).

The aqueous resin emulsion obtainable finally by multistage emulsion polymerization can be obtainable by polymerizing the polymerizable unsaturated monomer (b) in the presence of a pre-emulsion containing a copolymer obtainable by polymerization of the polymerizable unsaturated monomer (a).

Therefore, the aqueous resin emulsion comprises the copolymer of the polymerizable unsaturated monomer (a) and the copolymer of the polymerizable unsaturated monomer (b).

In the embodiment of the present invention, the multistage emulsion polymerization is performed in the presence of a surfactant comprising a sulfate ester salt having an allyl group and a polyoxyethylene group. The polymerizable unsaturated monomer (a) preferably comprises (a1) a (meth)acrylic acid ester, more preferably comprises, in addition to (a1), (a2) a monomer having an alkoxysilyl group and an ethylenic double bond, and particularly preferably comprises, in addition to (a1) and (a2), (a3) a monomer having a carboxyl group. The polymerizable unsaturated monomer (b) preferably comprises (b1) a (meth)acrylic acid ester, and more preferably comprises, in addition to (b1), (b2) a monomer having an alkoxysilyl group and an ethylenic double bond.

The aqueous resin emulsion obtainable by the multistage emulsion polymerization comprise two kinds of copolymers: a copolymer based on the polymerizable unsaturated monomer (a) used in a stage other than final stage, and a copolymer based on the polymerizable unsaturated monomer (b) used in the final stage. Two kinds of copolymers may have a multilayer (core-shell) structure. The aqueous resin emulsion comprising two kinds of copolymers can be applied onto various substrates because it is easy to form a film. Further, the durability (alcohol resistance, ester-based solvent resistance and plasticizer resistance) of the aqueous resin emulsion comprising two kinds of copolymers obtainable by the multistage emulsion polymerization is further improved.

When a sulfate ester salt having an allyl group and a polyoxyethylene group is used as the surfactant, the aqueous resin emulsion according to the embodiment of the present invention is significantly excellent in water resistance.

Therefore, an aqueous resin composition according to an embodiment of the present invention comprises the above-mentioned aqueous resin emulsion, so that the aqueous resin composition is excellent in coatability and durability (water resistance, alcohol resistance, ester-based solvent resistance and plasticizer resistance) and is easily applied onto various substrates, and is also suitable as a protective layer of the substrate.

The polymerizable unsaturated monomer (a) and the polymerizable unsaturated monomer (b) may be the same or different.

In the embodiment of the present invention, the polymerizable unsaturated monomer used in the multistage emulsion polymerization comprises the polymerizable unsaturated monomer (a) used in the stage other than the final stage and the polymerizable unsaturated monomer (b) used in the final stage, and the mass ratio ((b)/(a)) of (b) to (a) is preferably 30/70 to 70/30, and particularly preferably 40/60 to 60/40.

When the mass ratio of (b) to (a) is within the above ratio, the aqueous resin composition according to the embodiment of the present invention is excellent in balance between coatability and durability (water resistance, alcohol resistance, ester-based solvent resistance and plasticizer resistance).

The process of the multistage emulsion polymerization in the embodiment of the present invention will be specifically described below.

First, (a) a polymerizable unsaturated monomer is prepared in a container such as a flask. It is preferable that the polymerizable monomer (a) comprises (a1) a (meth)acrylic acid ester, (a2) a monomer having an alkoxysilyl group and an ethylenic double bond, and (a3) a monomer having a carboxyl group. These monomers are uniformly mixed to prepare (a) a polymerizable unsaturated monomer mixture.

To a sulfate ester salt having an allyl group and a polyoxyethylene group, water (or an aqueous medium) is added to obtain an aqueous solution. To this aqueous solution, the mixture of the polymerizable unsaturated monomer (a) is added to prepare (A) a monomer emulsion.

The polymerizable unsaturated monomer (a) includes (a1) the (meth)acrylic acid ester in an amount of more preferably 85 to 99 parts by mass, and particularly preferably 90 to 98 parts by mass, per 100 parts by mass of the polymerizable unsaturated monomer.

The polymerizable unsaturated monomer (a) includes (a2) the monomer having an alkoxysilyl group and an ethylene double bond in an amount of more preferably 0.05 to 1.0 parts by mass, and particularly preferably 0.4 to 0.8 part by mass, per 100 parts by mass of the polymerizable unsaturated monomer.

The polymerizable unsaturated monomer (a) includes (a3) the monomer having a carboxyl group in an amount of more preferably 0.5 to 10.0 parts by mass, and particularly preferably 2.0 to 6.0 parts by mass, per 100 parts by mass of the polymerizable unsaturated monomer.

When the polymerizable unsaturated monomer (a) has the above-mentioned composition, the durability (water resistance, alcohol resistance, solvent resistance and plasticizer resistance) of the coating film formed from the aqueous resin composition comprising the aqueous resin emulsion according to the embodiment of the present invention is improved in a well-balanced manner.

Separately from the monomer emulsion (A), (B) a monomer emulsion is prepared in another container. The monomer emulsion (B) can be prepared using the same method as the above-mentioned method for preparing the monomer emulsion (A).

Specifically, (b) a polymerizable unsaturated monomer is prepared in another container such as a flask. It is preferable that the polymerizable unsaturated monomer (b) comprises (b1) a (meth)acrylic acid ester and (b2) a monomer having an alkoxysilyl group and an ethylenic double bond. These monomers are uniformly mixed to prepare a mixture of the polymerizable unsaturated monomer (b).

To an aqueous solution of a sulfate ester salt having an allyl group and a polyoxyethylene group, the mixture of the polymerizable unsaturated monomer (b) is added to obtain (B) a monomer emulsion.

The polymerizable unsaturated monomer (b) includes (b1) the (meth)acrylic acid ester in an amount of more preferably 85 to 99.9 parts by mass, and particularly preferably 95 to 99.9 parts by mass, per 100 parts by mass of the polymerizable unsaturated monomer (b).

The polymerizable unsaturated monomer (b) includes (b2) a monomer having an alkoxysilyl group and an ethylenic double bond in an amount of more preferably 0.01 to 1.0 parts by mass, and particularly preferably 0.1 to 0.4 part by mass, per 100 parts by mass of the polymerizable unsaturated monomer (b).

When the polymerizable unsaturated monomer (b) has the above-mentioned composition, the durability (water resistance, alcohol resistance, solvent resistance and plasticizer resistance) of the coating film formed from the aqueous resin composition including the aqueous resin emulsion according to the embodiment of the present invention is improved in a well-balanced manner.

Next, water and a sulfate ester salt having an allyl group and a polyoxyethylene group are charged in a reactor equipped with a stirrer, a thermometer and the like, and a part of the monomer emulsion (A) and a catalyst are added. While maintaining the temperature in the reactor at a suitable temperature, the remainder of the monomer emulsion (A) and the catalyst are further added dropwise to prepare a pre-emulsion.

The monomer emulsion (B) and the catalyst are added dropwise to the pre-emulsion, followed by polymerization, and it is possible to synthesize an aqueous resin emulsion, which is a final product, by multistage emulsion polymerization.

In the present description, “aqueous medium” means common water such as tap water, distilled water, ion-exchange water and the like, may comprise water-soluble or water-dispersible organic solvents, such as acetone, ethyl acetate and the like, which are poorly reactive with raw materials (such as monomers) of the resin with regard to the present invention, and may further include water-soluble or water-dispersible monomers, oligomers, prepolymers and/or resins, and may also include emulsifiers, polymerizable emulsifiers, polymerization reaction initiators, chain extenders and/or various additives used usually in the production of aqueous or water-soluble resins, as mentioned below.

There is no particular limitation on the conditions of the polymerization reaction, such as reaction temperature and reaction time of the emulsion polymerization, kind and concentration of monomers, stirring rate, and kind and concentration of catalysts, as long as the aqueous resin emulsion according to the embodiment of the present invention is obtainable.

The “catalyst” is preferably a compound which is capable of causing emulsion polymerization of a polymerizable unsaturated monomer by the addition of a small amount, and can be used in an aqueous medium. Examples thereof include ammonium persulfate, sodium persulfate, potassium persulfate, t-butyl peroxybenzoate, 2,2-azobisisobutinitrile (AIBN) and 2,2-azobis(2-amidinopropane) dihydrochloride and 2,2-azobis(2,4-dimethylvaleronitrile) and the like, and ammonium persulfate, sodium persulfate and potassium persulfate are particularly preferable.

It is preferable that the copolymer of the polymerizable unsaturated monomer (a) has a glass transition temperature which is lower than that of the copolymer of the polymerizable unsaturated monomer (b).

In the embodiment of the present invention, the glass transition temperature of the copolymer of the polymerizable unsaturated monomer (a) is preferably −20 to 20° C., more preferably −10 to 20° C., and particularly preferably −10 to 15° C. When the glass transition temperature of the copolymer of the polymerizable unsaturated monomer (a) is within the above range, the durability, especially water resistance, of the aqueous resin emulsions according to the embodiment of the present invention is further improved.

In the embodiment of the present invention, the glass transition temperature of the copolymer of the polymerizable unsaturated monomer (b) is preferably 10 to 50° C., more preferably 25 to 50° C., and particularly preferably 30 to 50° C. When the glass transition temperature of the copolymer of the polymerizable unsaturated monomer (b) is within the above range, the durability, especially solvent resistance, of the aqueous resin emulsions according to the embodiment of the present invention is further improved.

In the present description, the glass transition temperature of the copolymer of the polymerizable unsaturated monomer (a) can be calculated from the glass transition temperature (also referred to as “homopolymer Tg”) of each homopolymer obtainable by homopolymerizing each of the polymerizable unsaturated monomer (a) (including (a1), (a2) and (a3).

The glass transition temperature can be calculated by considering this homopolymer Tg and the mixing ratio (mass ratio) of each of (a1), (a2) and (a3) in the polymerizable unsaturated monomer (a).

Similarly, the glass transition temperature of the copolymer of the polymerizable unsaturated monomer (b) is calculated from the glass transition temperature of each homopolymer obtainable by homopolymerizing each of the polymerizable unsaturated monomer (b) (including (b1) and (b2)) (hereinafter also referred to as “homopolymer Tg”).

Since (a2) and (b2) are used in essentially small amount, it is not necessary to make a consideration for the calculation of Tg in the present description.

Specifically, Tg of the copolymer (or resin) of the polymerizable unsaturated monomer can be determined by calculating using the following formula (1). In the formula (1), the polymerizable unsaturated monomer is expressed as a monomer:

1/Tg=C1/Tg1+C2/Tg2+ . . . +Cn/Tgn Formula (1):

wherein, in the calculation formula (1), Tg is a theoretical Tg of the copolymer (or resin) of the polymerizable unsaturated monomer (mixture), Cn is a mass percentage of the nth monomer n in the polymerizable unsaturated monomer mixture, Tgn is a homopolymer Tg of the nth monomer n, and n is the number of monomers constituting the copolymer and is a positive integer.

It is possible to use, as the homopolymer Tg, values mentioned in literatures. Such a literature includes, for example, POLYMER HANDBOOK (4th edition; published by John Wiley & Sons, Inc.). As an example, the homopolymer Tg of the monomers mentioned in POLYMER HANDBOOK is shown below.

Methyl methacrylate (“MMA”, Tg=105° C.)

n-Butyl acrylate (“n-BA”, Tg=−54° C.)

2-Ethylhexyl acrylate (“2EHA”, Tg=−70° C.)

Styrene (“St”, Tg=100° C.)

Acrylic acid (“AA”, Tg=106° C.)

Methacrylic acid (“MAA”, Tg=130° C.)

n-Butyl methacrylate (“BMA”, Tg=20° C.)

Cyclohexyl methacrylate (“CHMA”, Tg=83° C.)

In the present description, it is also possible to apply, in addition to Tg of each homopolymer obtainable by homopolymerizing each of the above monomers, glass transition temperature (Tg) of each homopolymer obtainable by homopolymerizing other monomers to the formula (1).

In the embodiment of the present invention, the aqueous resin emulsion may be neutralized according to properties of the aqueous resin emulsion which serves as a dispersoid. Here, the “neutralization” can be performed by adding an alkaline substance usually used for neutralization.

In the present description, the “alkaline substance” means a substance having a pH higher than 7 when dissolved in water. Usually, the form of the alkaline substance may be gaseous, liquid or solid, but a water-soluble form wherein the alkaline substance is made soluble in water is preferable because it is easy to handle and to control the neutralization reaction. Examples of such “alkaline substance” include ammonia, alkali metals such as sodium and potassium, and alkali earth metals such as calcium and magnesium. Ammonia water, an aqueous sodium solution and an aqueous potassium solution are preferable.

The alkaline substance is added so as to adjust the pH of the aqueous medium containing the aqueous resin to preferably 8.0 or higher, more preferably 8.0 to 10.0, and particularly preferably 8.0 to 9.5.

The aqueous resin emulsions of embodiments of the present invention preferably include a dispersoid (or aqueous resin) having an average particle size of 0.25 μm or less.

In the embodiment of the present invention, the average particle size of the dispersoid (or aqueous resin) is particularly preferably 0.05 to 0.20 μm. The average particle size in the present description means the particle size determined by measuring the particle size using the dynamic light scattering method and analyzing using the cumulant method using a PAR III (LASER PARTICLE ANALYZER) manufactured by Otsuka Electronics Co., Ltd.

The aqueous resin composition according to the embodiment of the present invention may optionally include pigments, fillers, rust preventives, thickeners, dispersants, defoamers, preservatives, film-forming aids and the like, which are known to those skilled in the art, as long as the aqueous resin composition comprises the aqueous resin emulsion according to the embodiment of the present invention.

The pigment is not particularly limited as long as it is usually used as a pigment. The pigment is usually classified into organic pigments and inorganic pigments.

Examples of the organic pigment include insoluble azo pigments such as fast yellow, diazo yellow, diazo orange and naphthol red; phthalocyanine pigments such as copper phthalocyanine; dye lakes such as fanal lake, tannin lake, and katanol; isoindolino-based pigments such as isoindolino yellow-greenish and isoindolino yellow-reddish; quinacridone-based pigments; and perylene-based pigments such as perylene scarlet and perylenemaroon, and the loke.

Examples of the inorganic pigment include carbon black, white lead, red lead, chrome yellow, vermilion, ultramarine, cobalt oxide, titanium dioxide, titanium yellow, strontium chromate, molybdenum red, molybdenum white, iron black, lithopone, emerald green, Guignet's green, cobalt blue and the like.

The filler means a substance added for the purpose of improving performance and reducing costs, and is not particularly limited as long as it is usually used as a filler. Specific examples thereof include calcium carbonate, magnesium carbonate, silica, talc, clay, alumina and the like.

The rust preventive means a substance added to a material in order to inhibit corrosion of the material, and is not particularly limited as long as it is usually used as a rust preventive. Examples thereof include red lead, white lead, lead suboxide, basic white lead sulfate, basic lead chromate, calcium plumbate, zinc chromate, cyanamide plumbate, sub-powder, dichloromate, barium chromate, sodium nitrite, dicyclohexyl ammonium nitrile, cyclohexylamine carbonate, rust preventive oil and the like.

The thickener is not particularly limited as long as it is usually used as a thickener. Example thereof include a modified acrylic polymer as an alkaline thickening type thickener, and a urethane-modified polyether and polyether as an associative type thickener. Examples of the alkaline thickening type thickener include hydroxyethyl cellulose (SP600 (trade name) manufactured by Daicel Chemical Industries, Inc.), SN thickener 615 (trade name) manufactured by SAN NOPCO LIMITED, A SE60 (trade name) manufactured by R&H Corporation, KA10K (trade name) manufactured by Henkel Japan Ltd. and the like. Examples of the associative type thickener include SN812 (trade name) manufactured by SAN NOPCO LIMITED, RM8W (trade name) manufactured by R&H Corporation, UH752 (trade name) manufactured by ADEKA Corporation and the like.

The dispersant is not particularly limited as long as it is usually used as a dispersant. Examples thereof include potassium tripolyphosphate manufactured by Taihei Chemical Industrial Co., Ltd., Primal 850 (trade name) manufactured by Rohm & Haas, DEMOL EP (trade name) manufactured by Kao Corporation, Discoat N-14 (trade name) manufactured by Dai-ichi Kogyo Seiyaku Co., Ltd., OROTAN 165A (trade name) manufactured by R&H Corporation, and SN DISPERSANT 5020 (trade name) manufactured by SAN NOPCO LIMITED.

The defoamer is not particularly limited as long as it is used as a defoamer. Examples thereof include hydrophobic silica, and metal soap-based, amide-based, modified silicone-based, silicone compound-based, polyether-based, emulsion-based, and powder-based defoamers. Examples thereof include NOPCO S N Deformer 777 (trade name) and SN Deformer VL (trade name) manufactured by SAN NOPCO LIMITED as hydrophobic silica; NOPCO NXZ (trade name) manufactured by SAN NOPCO LIMITED as the metal soap-based defoamer; NOPCO 267-A (trade name) manufactured by SAN NOPCO LIMITED as the amide-based defoamer; Silicone KM80 (trade name) manufactured by Shin-Etsu Chemical Co., Ltd. as the modified silicone-based defoamer; SN Deformer 121N (trade name) manufactured by SAN NOPCO LIMITED as the silicone compound-based defoamer; SN Deformer PC (trade name) manufactured by SAN NOPCO LIMITED as the polyether-based defoamer; NOPCO KF-99 (trade name) manufactured by SAN NOPCO LIMITED as the emulsion-based defoamer; SN Deformer 14-HP (trade name) manufactured by SAN NOPCO LIMITED as the powder-based defoamer and the like.

Examples of the preservative include ACTICIDE LG (trade name) and ACTICIDE MBS (trade name) manufactured by THOR Japan Co.

The film-forming aid is not particularly limited as long as it is usually used as a film-forming aid. Examples thereof include 2,2,4-trimethylpentanediol-1,3-monoisobutyrate (CS-12 (trade name) manufactured by Chisso Corporation), 2,2,4-trimethylpentanediol-1,3-diiisobutyrate (CS-16 (trade name) manufactured by Chisso Corporation), benzyl alcohol, butyl glycol, 2-ethylhexyl glycol and phenyl propylene glycol and dibutyl diglycol; organic esters of polyhydric alcohol monoalkyl ethers, such as dipropylene glycol mono-n-butyl ether, trypropylene monoglycol n-butyl ether, ethylene glycol mono ethyl ether, ethylene glycol mono-n-butyl ether and diethylene glycol mononobutyl ether; 3-ethoxypropionic acid esters, 3-methoxy-3-methyl-butyl acetate, benzoic acid esters, and adipic acid-based polyesters and so on.

The aqueous resin composition according to the embodiment of the present invention can be applied onto various common substrates such as metals, woods, plastics, inorganic building materials and the like, and is capable of coating and protecting a resin layer formed on the substrate.

For example, a resin is applied onto a plastic film, as a support for a heat-sensitive recording medium, and dried to form a heat-sensitive recording layer, to which layer the aqueous resin composition of the embodiment of the present invention is applied to form a protective layer.

As mentioned above, the aqueous resin emulsion according to the embodiment of the present invention has a small average particle size of 0.25 μm or less of a dispersoid included therein, so that the aqueous resin composition of an embodiment of the present invention penetrates very well into the wood. The aqueous resin composition according to the embodiment of the present invention penetrates into the wood and does not remain on a surface of the wood in a large amount, thereby improving the appearance of the wood, and the aqueous resin penetrated into the wood is possible to prevent the wood from rotting from the inside of the wood.

### EXAMPLES

Examples of the present invention will be described in detail below, but these Examples are only one embodiment of the present invention, and the present invention is not limited by these Examples.

Each of aqueous emulsions according to Examples was prepared from (A) a monomer emulsion and (B) a monomer emulsion. Polymerizable unsaturated monomers, surfactants and respective additives for the production of (A) and (B) are mentioned below.

The homopolymer Tg of the polymerizable unsaturated monomer is the literature value mentioned above, and Tg of the copolymer of the polymerizable unsaturated monomer (a) and the copolymer of the polymerizable unsaturated monomer (b) are the values calculated by the previously mentioned theoretical formula.

### <Polymerizable Unsaturated Monomer>

Methyl methacrylate (methyl methacrylate, hereinafter referred to as “MMA” (manufactured by FUJIFILM Wako Pure Chemical Corporation, Tg of homopolymer=105° C.) 2-Ethylhexyl acrylate (2-ethylhexyl acrylate, hereinafter referred to as “2EHA” (manufactured by FUJIFILM Wako Pure Chemical Corporation, Tg of homopolymer=−70° C.) n-Butyl acrylate (n-butyl acrylate, hereinafter referred to as “n-BA”) (manufactured by FUJIFILM Wako Pure Chemical Corporation, Tg of homopolymer=−54° C.) n-Butyl methacrylate (n-butyl methacrylate, hereinafter referred to as “n-BMA” (manufactured by FUJIFILM Wako Pure Chemical Corporation, Tg of homopolymer=20° C.) Cyclohexyl methacrylate (cyclohexyl methacrylate, hereinafter referred to as “CHMA” (manufactured by FUJIFILM Wako Pure Chemical Corporation, Tg of homopolymer=83° C.) 3-Methacryloxypropyltrimethoxysilane (manufactured by FUJIFILM Wako Pure Chemical Corporation) Acrylic acid (hereinafter referred to as “AA” (manufactured by FUJIFILM Wako Pure Chemical Corporation, Tg of homopolymer=106° C.)) Styrene (hereinafter referred to as “St” (manufactured by FUJIFILM Wako Pure Chemical Corporation, Tg of homopolymer=100° C.))

### <Surfactant>

Polyoxyethylene-1-(allyloxymethyl)alkyl ether sulfate ester ammonium salt (Aqualon KH10, manufactured by Dai-ichi Kogyo Seiyaku Co., Ltd.) (hereinafter also referred to as “S1), Polyoxyethylene styryl phenyl ether (manufactured by Kao Corporation, EMULGEN A-500) (hereinafter also referred to as “S2”)

### Example 1

A monomer emulsion was prepared from a plurality of polymerizable unsaturated monomers, and then a pre-emulsion was prepared from the monomer emulsion and an aqueous resin emulsion was synthesized from the pre-emulsion. Specific processes are as follows.

### (Preparation of (A) Monomer Emulsion)

As shown in Table 1, 5 parts by mass of (a1-1) MMA, 23 parts by mass of (a1-3) BA, 10 parts by mass of (a1-4) BMA, 10 parts by mass of (a1-5) CHMA, 2 parts by mass of (a3) AA, and 0.3 part by mass of (a2) 3-methacryloxypropyltrimethoxysilane were uniformly mixed to prepare (a) a polymerizable unsaturated monomer solution (50.3 parts by mass).

To a solution prepared by uniformly mixing 14 parts by mass of water and 0.1 part by mass of (S1) a polyoxyethylene-1-(allyloxymethyl)alkyl ether sulfate ester ammonium salt, the above polymerizable unsaturated monomer solution (a) was added, and then the mixed solution was stirred by a stirrer to obtain (A) a monomer emulsion.

(Preparation of (B) Monomer Emulsion) Separately from the monomer emulsion (A), (B) a monomer emulsion was prepared. Specific preparation is shown below. As shown in Table 1, 16.6 parts by mass of (b1-1) MMA, 13 parts by mass of (b1-3) BA, 10 parts by mass of (b1-4) BMA, 10 parts by mass of (b1-5) CHMA, and 0.1 part by mass of (b2) 3-methacryloxypropyltrimethoxysilane were uniformly mixed to prepare a (b) polymerizable unsaturated monomer solution.

To a solution prepared by uniformly mixing 14 parts by mass of water and 0.1 part by mass of (S1) a polyoxyethylene-1-(allyloxymethyl)alkyl ether sulfate ester ammonium salt, the above polymerizable unsaturated monomer solution (b) was added, and then the mixed solution was stirred by a stirrer to obtain (B) a monomer emulsion.

### (Synthesis Pre-Emulsion)

In a reactor equipped with a stirrer, a capacitor and a thermometer, 78 parts by mass of water and 1.25 parts by mass of (S1) a polyoxyethylene-1-(allyloxymethyl)alkyl ether sulfate ester ammonium salt were charged, and after replacing inside the system with nitrogen gas, the charge solution was heated to 80° C.

Subsequently, to the charge solution, the monomer emulsion (A) (which is a portion corresponding to 10.1 parts by mass of the polymerizable unsaturated monomer (a), while whole of the monomer emulsion (A) containing 50.3 parts by mass of the polymerizable unsaturated monomer (a)) and 2 parts by mass of an aqueous 1% by mass sodium persulfate (hereinafter also referred to as “SPS”) solution were added.

After additional 10 minutes, while maintaining the temperature in the reactor at 80° C., the remainder of the monomer emulsion (A) (which is a portion corresponding to 40.2 parts by mass of the polymerizable unsaturated monomer (a)) and 4 parts by mass of an aqueous 1% solution of SPS, which is a polymerization catalyst, were simultaneously added dropwise over 2 hours to obtain a pre-emulsion (aqueous resin emulsion based on the polymerizable unsaturated monomer (a)).

### (Synthesis of Aqueous Resin Emulsion)

The temperature in the reactor at 80° C. for 30 minutes after completion of the dropwise addition, and then the above monomer emulsion (B) (containing 49.7 parts by mass of the unsaturated polymeric monomer (b)) and 4 parts by mass of an aqueous 1% solution of SPS were simultaneously added dropwise over 2 hours respectively to obtain an aqueous resin emulsion.

The pH of the aqueous resin emulsion thus obtained was adjusted to 8.0 with ammonia water. With respect to the aqueous resin emulsion, the copolymer of the polymerizable unsaturated monomer (a) had a glass transition temperature of −3.8° C., the coplymer of the polymerizable unsaturated monomer (b) had a glass transition temperature of 26.7° C., and the aqueous resin emulsion had a solid concentration of 45% by mass. The solid content is the mass percentage of the remaining portion of the aqueous resin emulsion after drying in an oven at 105° C. for 3 hours relative to the mass of the aqueous resin emulsion before drying.

### Example 2 to Example 5

Monomer emulsions and aqueous resin emulsions were also synthesized in the same manner as in Example 1, using raw monomers as shown in Table 1.

The aqueous resin emulsions of Examples and Comparative Examples were evaluated by the following methods

### <Water Resistance>

Each of the aqueous resin emulsions obtained finally in Examples and Comparative Examples was applied onto a glass plate using a 5-mil applicator and immediately dried in a dryer at 105° C. to fabricate a resin film.

The film thus obtained was immersed in warm water at 50° C. and its state was confirmed after 24 hours. The evaluation criteria were as follows:

Coating film is transparent A: pass level
Coating film is thin and cloudy, but adheres onto glass plate B: pass level
Coating film is cloudy or peels from glass plate C: fail level

### <Alcohol Resistance>

Each of the aqueous resin emulsions obtained finally in Examples and Comparative Examples was applied onto a heat-sensitive recording paper (SD Standard heat-sensitive paper for word processing, manufactured by KOKUYO Co., Ltd.) using a bar coater and immediately dried in a dryer at 60° C. for 5 minutes to obtain a coated paper. One drop of isopropyl alcohol was fallen on the coated paper and its state was confirmed. The evaluation criteria were as follows:

Heat-sensitive paper was not discolored at all A: pass level
Heat-sensitive paper was slightly discolored B: pass level
Heat-sensitive paper turned black C: fail level

### <Ester-Based Solvent Resistance>

Using the same method as mentioned in the alcohol resistance test, except that the isopropyl alcohol used in the alcohol resistance evaluation was changed to ethyl acetate, the ester-based solvent resistance was evaluated. The evaluation criteria are as follows:

Heat-sensitive paper was not discolored at all A: pass level
Heat-sensitive paper was slightly discolored B: pass level
Heat-sensitive paper turned black C: fail level

### <Plasticizer Resistance>

Using the same method as mentioned in the alcohol resistance test, except that the isopropyl alcohol used in the alcohol resistance evaluation was changed to acetyl tributyl citrate, the plasticizer resistance was evaluated. The evaluation criteria are as follows:

Heat-sensitive paper was not discolored at all A: pass level
Heat-sensitive paper was slightly discolored B: pass level
Heat-sensitive paper turned black C: fail level

| | | | | | | Comparative | |
|---|---|---|---|---|---|---|---|
| | Example | | | | | Example | |
| Table 1 | 1 | 2 | 3 | 4 | 5 | 1 | 2 |
| Monomer emulsion (A) | | | | | | | |
| (a1-1) MMA | 5 | 18 | 21 | 15 | 15 | 5 | 57.2 |
| (a1-2) 2EHA | | 20 | 22 | 23.6 | | | 40 |
| (a1-3) BA | 23 | | | | 18 | 24 | |
| (a1-4) BMA | 10 | 5 | | 5 | 5 | 10 | |
| (a1-5) CHMA | 10 | 5 | | 5 | 10 | 10 | |
| (a2) 3-Methacryloxy- | 0.30 | 0.50 | 0.15 | 0.30 | 0.10 | 0.30 | 0.80 |
| propyltrimethoxysilane | | | | | | | |
| (a3) AA | 2 | 2 | 2 | 2 | 2 | 2 | 2 |
| (a4) St | | | 5 | | | | |
| Total mass of polymerizable | 50.3 | 50.5 | 50.15 | 50.9 | 50.1 | 51.3 | 100 |
| unsaturated monomer (a) | | | | | | | |
| Glass transition temperature | −3.8 | 0.93 | 0.8 | −9.9 | 17.0 | −5 | 7.5 |
| (Tg) ° C. of copolymer of | | | | | | | |
| polymerizable unsaturated | | | | | | | |
| monomer (a) | | | | | | | |
| (S1) Polyoxyethylene-1- | 0.1 | 0.1 | 0.9 | 0.13 | 0.1 | | 1.8 |
| (allyloxymethyl)alkyl ether | | | | | | | |
| sulfate ester ammonium salt | | | | | | | |
| (S2) Polyoxyethylenestyryl | | | | | | 0.2 | |
| phenyl ether | | | | | | | |
| Monomer emulsion (B) | | | | | | | |
| (b1-1) MMA | 16.6 | 22 | 33.7 | 23.7 | 16.8 | 16.6 | — |
| (b1-2) 2EHA | | 12.2 | 11 | | | | — |
| (b1-3) BA | 13 | | | 15.3 | 18 | 12 | — |
| (b1-4) BMA | 10 | 10 | | 5 | 5 | 10 | — |
| (b1-5) CHMA | 10 | 5 | | 5 | 10 | 10 | — |
| (b2) 3-Methacryloxy- | 0.10 | 0.30 | 0.15 | 0.10 | 0.10 | 0.10 | — |
| propyltrimethoxysilane | | | | | | | |
| (b3) AA | | | | | | | |
| (b4) St | | | 5 | | | | — |
| Total mass of polymerizable | 49.7 | 49.5 | 49.85 | 49.1 | 49.9 | 48.7 | 0 |
| unsaturated monomer (b) | | | | | | | |
| Glass transition temperature | 26.7 | 22.5 | 44.1 | 26.4 | 16.9 | 29 | — |
| (Tg) ° C. of copolymer of | | | | | | | |
| polymerizable unsaturated | | | | | | | |
| monomer (b) | | | | | | | |
| (S1) Polyoxyethylene-1- | 0.1 | 0.1 | 0.9 | 0.13 | 0.1 | | — |
| (allyloxymethyl alkyl ether | | | | | | | |
| sulfate ester ammonium salt | | | | | | | |
| (S2) Polyoxyethylenestyryl | | | | | | 0.2 | — |
| phenyl ether | | | | | | | |
| In-reactor | | | | | | | |
| (S1) | 1.25 | 1.25 | 0.2 | 1.25 | 1.8 | | 0.2 |
| (S2) | | | | | | 0.4 | |
| Water resistance | A | A | B | A | A | C | A |
| Alcohol resistance | A | A | B | A | B | C | C |
| Ester-based solvent resistance | A | A | B | A | B | C | C |
| Plasticizer resistance | A | A | B | A | B | C | C |

As shown in Table 1, the aqueous resin emulsions of Examples are obtained by multistage emulsion polymerization of specific polymerizable unsaturated monomer in the presence of a sulfate ester salt having an allyl group and a polyoxyethylene group as a surfactant, and are excellent in all performances of water resistance, alcohol resistance, ester-based solvent resistance and plasticizer resistance, and can be coated onto both a glass plate and a heat-sensitive recording paper.

With regard to the aqueous resin emulsion of Comparative Example 1, a sulfate ester salt having an allyl group and a polyoxyethylene group was not used as the surfactant, but a surfactant having no sulfate ester salt (polyoxyethylene styrene phenyl ether) was used. Therefore, the aqueous resin emulsion of Comparative Example 1 is inferior in all performances of water resistance, alcohol resistance, ester-based solvent resistance and plasticizer resistance.

With regard to the aqueous resin emulsion of Comparative Example 2, although a sulfate ester salt having an allyl group and a polyoxyethylene group was used as the surfactant, the aqueous resin emulsion was synthesized by normal emulsion polymerization (single stage polymerization) rather than multistage emulsion polymerization. Therefore, the aqueous resin emulsion of Comparative Example 2 includes only one kind of resin and is excellent in water resistance, but is inferior in other durability performances (alcohol resistance, ester-based solvent resistance and plasticizer resistance).

As mentioned above, it has been established that the aqueous resin emulsion according to the embodiment of the present invention is excellent in water resistance, alcohol resistance, ester-based solvent resistance and plasticizer resistance, and has well-balanced durability.

### INDUSTRIAL APPLICABILITY

The present invention can provide an aqueous resin emulsion which can be used in various fields such as laminates, wood materials, paper substrates, plastic films, resin layers and so on.

The aqueous resin composition comprising the aqueous resin emulsion is suitable for the production of sanitary materials, building materials, laminated films, packaging materials, electronic materials, heat-sensitive recording media and the like.

### CROSS-REFERENCE TO RELATED APPLICATION

This application claims priority under Article 4 of the Paris Convention based on Japanese Patent Application No. 2019-224681 filed on Dec. 12, 2019 in Japan. This priority patent application is incorporated herein by reference in its entirety.

1. An aqueous resin emulsion obtainable by multistage emulsion polymerization of plural kinds of polymerizable unsaturated monomers in the presence of a surfactant, (a) a polymerizable unsaturated monomer being polymerized in a stage other than the final stage, while (b) a polymerizable unsaturated monomer being polymerized in the final stage, wherein
the surfactant comprises a sulfate ester salt having an allyl group and a polyoxyethylene group,
the aqueous resin emulsion comprises a copolymer of the polymerizable unsaturated monomer (a) and a copolymer of the polymerizable unsaturated monomer (b),
the copolymer of the polymerizable unsaturated monomer (a) has a glass transition temperature lower than that of the copolymer of the polymerizable unsaturated monomer (b),
the polymerizable unsaturated monomer (a) and the polymerizable unsaturated monomer (b) comprise a (meth)acrylic acid ester and a monomer having an alkoxysilyl group and an ethylenic double bond, and
the polymerizable unsaturated monomer (a) comprises (a2) a monomer having an alkoxysilyl group and an ethylenic double bond in an amount of 0.05 to 1.0 parts by mass per 100 parts by mass of the polymerizable unsaturated monomer (a).

2. The aqueous resin emulsion according to claim 1, wherein the polymerizable unsaturated monomer (a) further comprises a monomer having a carboxyl group.

3. An aqueous resin composition comprising the aqueous resin emulsion according to claim 1.

4. A substrate coated with the aqueous resin composition according to claim 3.
